(19) United States
(12) Patent Application Publication
(10) Pub. No.: US 2005/0255431 A1
(43) Pub. Date: Nov. 17, 2005

(54) Interactive language learning system and method

(75) Inventor: James K. Baker, Maitland, FL (US)

Correspondence Address: FOLEY AND LARDNER;SUITE 500, 3000 K STREET NW, WASHINGTON, DC, 20007, US

(73) Assignee: Aurilab, LLC

(21) Appl. No.: 11/128,325

(22) Filed: May 13, 2005

Related U.S. Application Data
(60) Provisional application No. 60/571,512, filed on May 17, 2004.

(51) Int. Cl. G09B 19/06; G09B 19/08; G09B 5/00

(52) U.S. Cl. 434/169

(57) ABSTRACT

A method of interactive language instruction includes obtaining a sequence of basic units to present to a student. The method also includes obtaining a plurality of alternate representations for each of a plurality of the basic units. The method further includes presenting at least a portion of the sequence of basic units to the student. The method also includes obtaining input from the student during the presenting of the basic units. For at least one of the sequence of basic units to be presented to the student and the input from the student, segmentation is performed to break up a continuous stream of units into a sequence of discrete units. For at least one particular basic unit with the plurality of alternate representations, at least one of the alternate representations is automatically selected to present to the student based at least in part on the input obtained from the student during the presentation of basic units that are earlier in the sequence of basic units than the particular basic unit.

### RELATED APPLICATIONS

This application claims priority to provisional patent application 60/571,512, entitled “Interactive Language Learning System and Method,” filed May 17, 2004, which is incorporated in its entirety herein by reference.

### BACKGROUND OF THE INVENTION

A. Field of the Invention

The invention relates to an interactive language learning system and method, which utilizes a sequence of basic units to enable a student to learn a language.

B. Description of the Related Art

A child learns its first language merely by being immersed in an environment in which the language is used by everyone around the child. In particular, the language is not translated into another language that the child already knows. Many language instruction methods are based on a concept of “immersion” in an attempt to provide some of the learning experience of a child learning a first language. However, true immersion is both very expensive and very time consuming. Practical language instruction methods therefore generally try to imitate only certain aspect of the immersion experience. In particular, a common attribute of language instruction based on the concept of “immersion” is specifically not to provide translations of words in the new language into the student's native language. However, for many students this restriction is a significant handicap rather than a help.

For a busy person, a different attribute of immersion is much more helpful. One aspect of true immersion is that the learning of the language is embedded into the learner's ordinary daily activities. Most language instruction, except very expensive 24-hour per day immersion, is done as a separate activity in addition to and generally apart from the student's regular activities. Even methods based on the concept of “immersion,” whether done by human instructors or computer software, are generally done as a separate activity, often at a special location, with the need to schedule time away from other activities.

Another desirable attribute for language learning is the ability for the student to interact with the teacher or at least with other people who know the language. However, dedicated human instruction is very expensive. There is a need to make the human instruction time more efficient and less expensive. However, for any practical method there will also be a need for self-instruction. For self-instruction it is desirable to give the student the ability to interact with the instructional system and to make the interaction as much as possible like the interaction between a student and a human teacher.

However, many self-instruction systems consist of an audio recording in which a native speaker says a word or phrase and then the student repeats the same thing, with no interaction at all. Better systems are designed to use a question or prompt in which the student's response will be different from the prompt. Such systems must be carefully designed so that both the question or prompt and the response that the student must construct will be within the student's capacity at a given point in the instruction. However, although more expensive to develop, such systems still lack the essential property for an interactive system. The system doesn't actually listen to the student's response. It does not change its behavior based on the student's response. It does not adjust the lesson plan or even individual prompts based on student's response. The audio material is pre-recorded and is presented in a fixed order regardless of what the student says and regardless of how well the student pronounces it.

Another problem in preparing language instructional material is that students have a wide range of degrees of knowledge of the language being studied. Generally, students are divided into broad categories, such as beginning, intermediate and advanced. Then separate material is prepared for each category of student. However, there is a great deal of variability even within each of these categories. It is expensive to prepare separate material for each category of student and would be much more expensive to prepare separate material for much finer categories, or for individual students. A method is needed that will allow the same basic material to be used across a broad range of student abilities, yet be automatically tailored to the needs of an individual student.

An additional issue in preparing language instructional material is that there are multiple modalities. In a given prompt/response pair, the material can be presented to the student in either written or spoken form, in either the language being studied or in the student's native language. The student's response may be either spoken or written (or other computer input modalities).

The learning experience can be enhanced in several ways. Students often learn better and remember more when they learn by doing a project or task. Learning is enriched when students work together with other students. Language students benefit greatly from contact with native speakers of the language they are studying. A study scenario that incorporates all of these enhancements is a student team project to translate material from one language, the source language, to another, the target language. An ideal team will include native speakers of both the source language and the target language, each studying the other language, and working together to perform the translation task. However, it may be difficult to collect such a multi-lingual team in one location.

Language processing tasks that could be done as projects by such student teams include transcription of speech to text, translation and summarization. Automatic systems are available to aid in these tasks. However, these automatic systems are imperfect and make errors. These automatic systems are trainable and will learn to perform better if there is a sufficiently large corpus of linguistic data to use for training them. Particularly valuable is data in which an automatic system has made an error and the error has been corrected by a human. However, collecting such linguistic data is expensive and in many languages not enough data is available.

Thus, there is a desire to address one or more of the problems described above in conventional language instruction methods and systems

### SUMMARY OF THE INVENTION

According to one aspect of the invention, there is provided a method of interactive language instruction. The method includes obtaining a sequence of basic units to present to a student. The method also includes obtaining a plurality of alternate representations for each of a plurality of said basic units. The method further includes presenting said sequence of basic units to said student. The method still further includes obtaining input from said student during said presenting of said basic units. For at least one of said sequence of basic units to be presented to said student and said input from said student, segmentation is performed to break up a continuous stream of units into a sequence of discrete units. For at least one particular basic unit with said plurality of alternate representations, at least one of said alternate representations is selected to present to said student based at least in part on said input obtained from said student during said presentation of basic units that are earlier in said sequence of basic units than said particular basic unit.

According to another aspect of the invention, there is provided a method for linguistic data collection. The method includes assigning a language processing task to at least one student, said language processing task including at least one of transcription of speech, translation from a source language to a target language, and summarization. The method also includes recording and saving spoken and text data of said at least one student produced in a process of performing said assigned language processing task as linguistic data. The method further includes creating a collection of linguistic data for a plurality of instances of assigning the language processing task to the at least one student.

According to yet another aspect of the invention, there is provided a method for training an automatic language processing system. The method includes obtaining an initial set of models for at least one automatic language processing system. The method also includes repeating the following steps a plurality of times:
i. assigning a language processing task to a student team;
ii. having said student team perform said language processing task with the aid of said at least one automatic language processing system;
iii. having said student team correct the errors made by said at least one automatic language processing system; and
iv. accumulating data from a plurality of task assignments in this repeated process.
   The method further includes updating language models in said at least one automatic language processing system based on said accumulated data.

### BRIEF DESCRIPTION OF THE DRAWINGS

The foregoing advantages and features of the invention will become apparent upon reference to the following detailed description and the accompanying drawings, of which:

FIG. 1 is an overall flowchart of one embodiment of the invention.

FIG. 2 is a flowchart of a first example of one embodiment of the invention in which a students views and listens to a movie or video.

FIG. 3 is a flowchart of a second example of one embodiment of the invention in which a student reads a text presentation aloud.

FIG. 4 is a flowchart of an example of one embodiment of the invention in which a linguistic data collection process is utilized while a team of students with varying language skills work together to create a summary in a target language of a news broadcast in a source language different from the target language.

FIG. 5 is a flowchart of a process of preparing a transcription as part of the embodiment of the invention shown in FIG. 4.

FIG. 6 is a flowchart of a process of preparing a translation as part of the embodiment of the invention shown in FIG. 4.

FIG. 7 is a flowchart of a process of preparing a summary as part of the embodiment of the invention shown in FIG. 4.

FIG. 8 is a flowchart of another embodiment of the invention in which a student is using a communications system to communicate with other students.

FIG. 9 is a flowchart showing another embodiment of the invention which includes a communications system for communication among a group of students.

FIG. 10 is a flowchart of another embodiment of the invention in which data collected from student task assignments is used to train models for automatic language processing systems.

### DETAILED DESCRIPTION OF THE INVENTION

A detailed description of the invention is provided herein, with reference to the accompanying drawings.

The invention is described below with reference to drawings. These drawings illustrate certain details of specific embodiments that implement the systems and methods and programs of the present invention. However, describing the invention with drawings should not be construed as imposing on the invention any limitations that may be present in the drawings. The present invention contemplates methods, systems and program products on any machine-readable media for accomplishing its operations. The embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention will be described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD-ROM or other optical media. The drives and their associated machine-readable media provide nonvolatile storage of machine-executable instructions, data structures, program modules and other data for the computer.

One aspect of immersion is that a language being learned should be embedded into the student's regular daily activities. There are many daily activities that involve reading or listening: watching television, reading a newspaper, listening to news on the radio, watching a video, etc. Usually these activities are done exclusively in the student's native language. Only the most advanced students would be able to do them entirely in the language they are learning.

According to at least one embodiment of the invention, these daily activities are allowed to be done in a mixture of the two languages, with the amount that is in the foreign language being automatically adjusted to the level of proficiency of the individual student. It can even be adjusted dynamically based on the particular vocabulary items that occur in a given piece of material, and the individual student's familiarity with those vocabulary items.

Another aspect of the embodiment of the invention is that the material may be in either written or spoken form. If a response is called for on the part of the student, it may be spoken, typed or entered on a keyboard, keypad or with a computer mouse. By using large vocabulary speech recognition and speech synthesis, a conversion as needed can be made from one modality to another.

The audio or video material will generally be in the form a continuous stream. However, the student's interaction with the material and with the instructional system may need to be in terms of discrete units, such as words. In particular, if the system is to provide material in a mixture of two languages that is responsive to the student's knowledge of particular vocabulary words, it will need to know for each word the time within the continuous audio or audio/video stream of the beginning and ending of the particular word. To provide the student the capability to interact with the system and to request assistance on a particular word will also require such a time alignment. Such a time alignment may be computed by a large vocabulary continuous speech recognition system.

The present invention may be applied to age-appropriate material for ages ranging from pre-school age children to adults. Even the youngest children can watch cartoons or listen to stories read aloud. Older children can read comic books and stories matched to their grade level. Adults can view movies, read books and newspapers, and listen to radio and audio books. At any age, the material could be the same kind of material that the student would read, watch or listen to in the student's native language, just for entertainment or information. The language instruction would be gradually and seamlessly integrated into the student's daily life. Furthermore, the same age-appropriate material can be used by students at all levels of proficiency in the language being studied.

The present invention may also be used for language study in which a student does a project alone or, preferably, with a group of fellow students. The student team may include students who are native speakers of the language being studied by the first student. The students can help each other learn the other's language.

The projects may be done by students working as a team and may also be aided by automatic language processing systems such as automatic speech recognition, machine translation and natural language processing such as for the generation of summaries. Data collected from the performance of the language processing assignments by teams of students may be used to update and improve the models used by the automatic language processing systems.

In the description provided herein below, many steps involve two languages: the language being studied and the “native language” of the student. This embodiment of this invention can work with any two languages. It is desirable, but not essential, that the student be fluent in the language referred to as the student's “native language” or at least that the student be more familiar with that language than the language being studied. Because in most cases, this language will be the student's native language, for clarity the descriptions have been written using the phrase “student's native language.” However, it should be understood that wherever the phrase “student's native language” appears in the descriptions, the embodiment could use any other language with which the student is familiar.

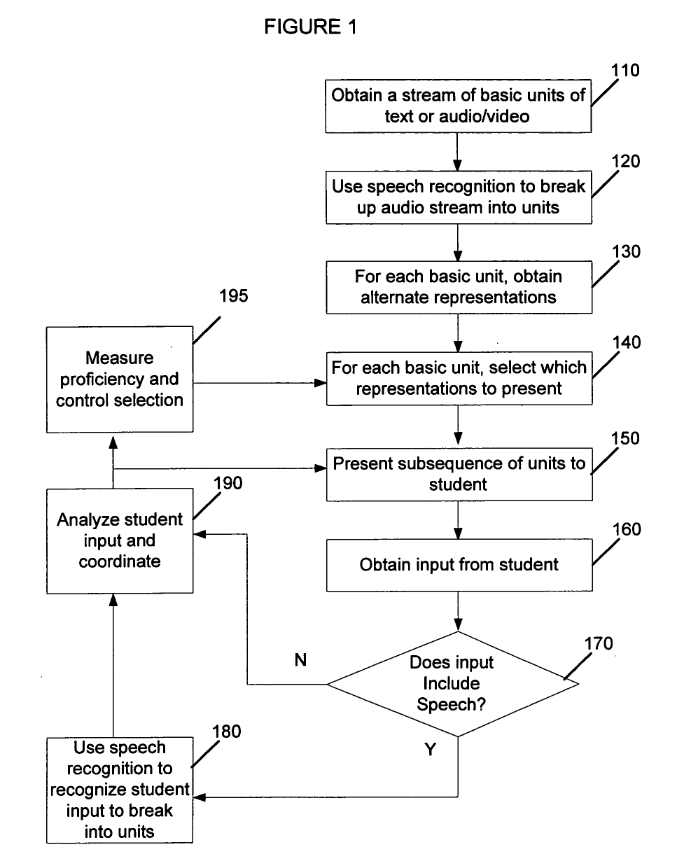

Referring now to FIG. 1, which illustrates a first embodiment of the invention, block 110 obtains a stream of material to present to the student. This material may be written text, spoken audio, or video with accompanying audio, or a mixture of these. In an implementation of the first embodiment, this material would be the same kind of material that the user (that is, the student) would normally read, view or listen to even without the objective of learning a language. For example, the material might be a movie video or a radio news program. Thus, the original form of the material might include a continuous audio stream that is not broken up into words. The material may be in the language being studied, or in a mixture of the language being studied and the student's native language.

Block 120 breaks up any continuous audio stream of spoken language into basic units using a large vocabulary continuous speech recognizer, such as Carnegie Mellon University's Sphinx recognizer. Typically, the basic units will be words or phrases, but in alterative implementations of this embodiment the units might be sub-word units such as individual sounds or phonemes, or might be longer units such as phrases or sentences. If the transcription of the audio stream is not known, a transcription may be obtained either by using the continuous speech recognizer or from human transcribers. In an implementation of the first embodiment, the continuous speech recognizer is used to obtain a rough transcript and a clean transcript is obtained by having one or more teams of students or individual students correct the errors in the rough transcription as a student exercise. Once a transcription is available, a time alignment is computed between the audio stream and a network representing the sequence of words in the transcription, by a process that is called “forced alignment,” which is well-known to those skilled in the art of speech recognition and is shown in pseudo code A provided in a later portion of this section. Once the time alignment is obtained, the continuous audio stream is segmented into discrete basic units by segmenting the continuous audio stream at the times that align to the beginnings and endings of words or other basic units in the transcription network.

If the original material is purely written text without accompanying audio, in an alternative implementation of the first embodiment, audio is obtained either by having a person read the text or by generating it artificially using a text-to-speech synthesizer.

Once the stream of material is broken up into discrete basic units, it can be determined on a unit-by-unit basis how the individual unit will be presented. In particular, a choice can be made for each individual word as to whether the word will be presented in the language being studied or in the student's native language.

Block 130 obtains alternate representations for each basic unit. There are several choices for alternate representations. Which of these choices are to be made available in a given presentation will depend on the particular objectives and preferred study style of the student, and may also be determined due to educational objectives of the teacher. In an implementation of the first embodiment, one or more of the representations will be given in the initial presentation and the other representations will be available as needed based on the interaction with the student.

The alternate representations include the basic unit and its translation, so that it is available both in the native language of the student and in the language being studied. If such a translation is not available initially, in one implementation of the first embodiment it may be obtained by having professional translators translate the material. In an implementation of the first embodiment, the translation may be prepared as an exercise by a group of advanced students working as a team, working with a preliminary version of the material before the final version is released more broadly. In an implementation of the first embodiment, the team exercise would be designed to enhance the learning experience of the student team members through mutual motivation and team spirit.

The alternate representations may include written representations, spoken representations, translations, definitions, or glosses. For each language, the representations may include either or both written and spoken representations. If a given form of desired representation is not available, it may be obtained by any of several means. If only the written form is available, in an implementation of the first embodiment, recordings may be made by having native or fluent speakers of the given language read a given passage aloud. In an alternate implementation of the first embodiment, the spoken form may be obtained by using a text-to-speech synthesis system. The number of alternate representations to be provided to the student may be based on the proficiency level of the student, whereby a more proficient student will be provided with a lesser number of alternate representations for a same sequence of basic units.

If only the spoken form is available and the written form is desired as an alternate representation, then the transcript may be obtained by hiring professional transcribers in the particular language. In an implementation of the first embodiment, the transcript is obtained by having one or more students prepare transcripts as a student exercise. In an implementation of the first embodiment, the exercise is done by a group of students working as a team to get higher accuracy and reliability. In an implementation of the first embodiment, an initial transcript is obtained using a large vocabulary, continuous speech automatic speech recognition system. In an implementation of the first embodiment, even when a transcript is already available an errorful version of the transcription will be made available to some students to correct as a student exercise.

Other alternate representations include words presented with glosses. For example, in a written presentation a word might be presented as the normal written word or phrase followed by a translation of the word or phrase in brackets, as in “homme[man].” In this example, the basic unit is the word “homme” (in French) and the bracketed expression “[man]” is a gloss which is the translation of the word into English. In other cases, the gloss may be a definition or explanation, which may be given in either the native language of the student or the language being studied.

Alternate representations for spoken forms include spoken forms recorded at different speaking rates or recordings modified to be played back at different speeds.

In an implementation of the first embodiment, relationships among the alternate representations are specified indicating that certain alternate forms will be easier for a student than other alternate forms. For example, an alternate representation that includes a form in the student's native language is specified as being easier than a representation that does not include such a form. An alternate form that includes a gloss is specified as being easier than a form that does not include a gloss. A spoken or written form is not necessarily specified as being easier than the opposite form. However, the teacher may optionally make such a specification based either upon the student's objectives and overall proficiency or based on the purpose of a given exercise or lesson. The easier forms of presentation will be presented based on requests from the student or based on student need. The easier forms may selectively be presented based on measured proficiency on particular basic units. As a presentation proceeds, or in presentations in later lessons, the relative rate of presentation of easier forms may be adjusted based on the student's overall proficiency and rate of progress.

Block 140 selects for each basic unit which of the alternate representations to present. A given subsequence of basic units may be presented more than once, based on responses from the student or requests from the student. The initial presentation may include more than one alternate representation, depending on the student's proficiency and preferences. For example, if the student is watching and listening to a video, subtitles may be presented at the same time.

The speech in the video, as obtained in block 110 above, will usually be a stream of continuous speech. Block 120 above will break the continuous stream of speech into basic units such as words. Block 140 thereby may make different selection decisions for each basic unit, based on the student's proficiency in the language being studied and the student's familiarity with the particular lexical items in a particular basic unit, and/or based on the degree of difficulty of the material. For example, for a beginning student, the speech can be mostly in the student's native language, with occasional substitutions of words from the language being studied. For an advanced student, the speech may be entirely in the language being studied, possibly with subtitles. An intermediate student may have a greater mixture of the two languages. The subtitles may be either a transcription of speech as presented, or may be a translation. Additional information may be presented in either written or spoken form as a result of input or requests from the student, as will be explained more fully with regard to other blocks of the flowchart.

Block 150 presents a subsequence of units to the students, including alternate representations as selected by block 140. There may be pre-selected breaks in the overall sequence to be presented at which the system pauses to wait for a response from the student, or the sequence may be presented as a continuing stream but with the student having the ability to interrupt the presentation. The presentation made by block 150 may be audio, audio combined with video, or may be a written sequence. Mixtures of these modalities may also be used.

Block 160 obtains input from the student. This input may be spoken, typed at a keyboard or keypad, or may use other input devices such as a computer mouse. The student's input may be a response to a prompt from the language instruction system, or may be a spontaneous input generated by the student. The system may prompt the student by asking a question, or may request that the student speak a particular passage. The student may be answering questions, repeating prompts, speaking spontaneously, asking for help, and/or giving commands to the system. In an implementation of the first embodiment, the presentation by block 150 is in written form and the student's response is to read each passage aloud. In another aspect of the first embodiment, the overall sequence of basic units may be broken into subsequences forming exercises, with one or more questions or prompts at the end of each exercise.

In another implementation of the first embodiment, the input from the student will be spontaneous, and will be for the purpose of controlling the presentation or of asking for additional information. For example, the student may request that a particular passage be repeated. The student could control the speed of presentation of audio material, including the selection of alternate representations that have been recorded at different speaking rates or that have been modified to be played back at different speeds. The student could control the selection criteria for alternate representations. For example, the student could request that more glosses be provided. The student would be able to select a particular basic unit and ask for more information about that particular basic unit, such as a translation, a definition or an explanation. The student could also ask for more information or help with higher level analysis, such as grammar or syntax.

Block 170 checks to see if some or all of the input from the student is in spoken form, since the student input may or may not be spoken. If so, block 180 recognizes the student's speech and breaks it into units and also recognizes whether the input from the student constitutes a spoken command or request. The speech recognizer also checks whether the student's spoken input correctly matches an expected response or whether it matches the right or a wrong answer to a question which the system has asked the student. In another implementation of the first embodiment, the speech recognition system also performs other analysis to help evaluate the student's performance and needs.

For example, block 180 may check the pronunciation of the student by performing pattern recognition of the student's speech with a model derived from native speakers. This pattern matching may be performed by an automatic speech recognition system such as Carnegie Mellon University's Sphinx system and may, for example, be done using a quantity computed as part of a forced alignment computation as illustrated in pseudo code A, provided at a later portion of this section. Block 180 may also measure fluency of the student's speech and whether there are pauses or other verbal gestures indicating uncertainty.

Block 190 analyzes the input from the student, including interpreting any commands or requests from the student and evaluating the responses of the student to any questions or prompts. For spoken input from the student, the analysis in block 190 also integrates the results of the speech recognition and analysis performed by block 180.

In an implementation of the first embodiment, the instruction consists of a mixture of self-study, student team projects, and instruction mediated by a human teacher, tutor or mentor. Block 190 coordinates the study or work being done by the individual student with other students and with the teacher or mentor. For example, the input from the student may be a request for more information or help. The teacher may be in the same room as the student, or they might only be connected through a computer network such as the Internet. Even if in the same room, the teacher may be busy at any given moment, for example, helping other students. If connected by computer network, the student and teacher are not necessarily connected to the network at the same time. The control includes repetition of subsequences and selection of alternate representations to present to the student, and the control may include coordination with a mentor or other student team members.

In any of the cases in which the teacher or mentor does not immediately reply to the student's request, the request is recorded and forwarded to the teacher by means such as e-mail. Block 190 will coordinate the forwarding of the request and track any future response from the teacher as a response to the particular request.

More frequently, the student will make a request for more information or help from the interactive system, rather than a direct request to the teacher. In this case the system will respond directly, and block 190 will record the request and based on criteria specified by the course designer and by the teacher, may forward the request to the teacher for monitoring the student's request and the system's response. In this case, the teacher may choose to supply an additional response, at the teacher's option.

This networking allows the teacher or mentor to be in a different location and perhaps working at a different time than the student. This is an aspect of the invention that enables the human teacher or mentor to be more efficient. The on-going measurement of the student's proficiency, specific to each word or lexical unit, also enables the teacher to be more efficient. The teacher can tell exactly where the student is having difficulty and provide extra assistance where it is needed most. The instruction is also made more efficient because the self-study activity of the student is highly adaptable and is controlled by criteria set by the teacher.

In another implementation of the first embodiment, the student may be doing a team project with other students. Similar projects can also be done by individual students. Referring to block 190 of FIG. 1, however, block 190 performs coordination of projects done by teams of students. Such projects may be designed to fit the degree of proficiency of the students and may be performed in various modalities.

For example, a student project may consist of a creative writing exercise. More advanced students may write something new from scratch. Less advanced students may have the task of editing a piece of writing that has already been prepared. The piece of writing to be edited may be a piece written by other students, or may be written material obtained from external sources. For the editing exercise, errors may be deliberately introduced so that part of the student's exercise is to find and fix such errors.

Another example project is to transcribe a spoken presentation into a written form. In an implementation of the first embodiment, one way of adjusting the difficulty of the project to fit the proficiency of the students is to adjust the selection of alternate representations as described above in reference to block 130 and block 140. In addition, the degree of difficulty of the transcription task may be adjusted by provided partial or complete, but errorful, transcriptions. The errorful transcriptions may be obtained from a speech recognition system or may be obtained by artificially adding errors to a clean transcription. Furthermore, these transcriptions may again include alternate representations such as glosses and translations.

Another example project is to translate a passage or document from one language to another. Either the original language of the document or the target language of the translation would be the language being studied. The other language would be a language that the student knows well, such as the student's native language. In an aspect of the first embodiment, a given student project team will include some team members whose native language is the original language of the document and some other team members whose native language is the target language of the translation. Thus students who are studying each other's native language will be able to cooperate in a team project. Having some team members who are native speakers of the target language of the translation will improve the fluency of the translation and enable greater use of idioms that might not be known even to advanced students who are not native speakers of the language.

For less advanced students, the translation task may be from the foreign language to the student's native language and a partial translation or a complete but errorful translation may be provided for editing. The errorful translation may be obtained from a machine translation system, or may be obtained by artificially adding errors to a clean translation. The errorful translation may also be obtained from earlier student projects.

In an implementation of the first embodiment, the material for team projects, as well as study material for individual projects or ordinary self-study, will be age-appropriate material of the kind that the student would normally use in the student's native language regardless of any language learning objective. It would be material the student would watch, listen to, or read for entertainment or informational value as a regular, preferably daily activity. It is an aspect of the invention that all the study material, including the student team projects coordinated in block 190, can be adaptable for students of varying levels of proficiency.

To facilitate the formation and cooperation of student teams, block 190 connects each student to a computer network, such as the internet, so that the student members of a given team may be in geographically separate locations. For example, in a team project to translate a document from Japanese to English, some team members may be in Japan while other team members are in the United States. To fit time schedules for busy students, who for example may be adults with full time jobs, and to accommodate team members from different time zones, block 190 includes team collaboration software designed to facilitate and track communication between team members who are not necessarily working together at the same time. On the other hand, to increase the feeling of team spirit and motivation and commitment to a common goal, block 190 also includes software to facilitate real-time meetings in which the student team members are all connected to the computer network at the same time and have shared access to software and data and have communications means such as instant messaging and voice-over-IP (VOIP). In an implementation of the first embodiment, it will be recommended to student teams that each team have at least some regularly scheduled real-time team meetings.

Block 190 records all of the communications between the student team members and their joint work for evaluation by the instruction system and human instructors. The teacher can use this material to evaluate the proficiency and progress of each student and also to determine if a student team or an individual student needs extra help.

Referring to the aspect of block 190 in which the student has made a request for a repetition of a given section of the sequence of basic units, there is a control connection from block 190 to block 150. This control may also be used to repeat certain material when the analysis of the student's input indicates the need for repetition based on criteria set by the course designer and the teacher. For example, basic units on which the student's proficiency is less than desired may be repeated.

Block 195 measures the proficiency of the student and controls the selection of alternate representations made in block 140. The proficiency of the student is measured not merely in terms of overall average proficiency, but also in terms of knowledge of individual basic units such as particular words or other lexical units such as phrases with particular meanings. Furthermore, the student's proficiency may be measured with respect to each of the modalities: the student's ability to recognize and understand the written form; the student's ability to recognize and understand the spoken form; the student's ability to use the written form in new writing produced by the student; and the ability of the student to speak the basic unit, to use it correctly in a spoken sentence and to pronounce it correctly.

The first embodiment uses several different ways to measure the student's proficiency and knowledge of each particular basic unit. As a first measure, an implementation of the first embodiment counts the number of times a particular basic unit has been presented to the student. In particular, the system and method according to an implementation of this embodiment keeps track of information corresponding to which particular units have not yet been presented at all; The system and method according to an implementation of the first embodiment also measures how frequently each particular basic unit has been presented and how many times it has been presented in a given recent time interval.

The first embodiment also measures the student's accuracy in the use of the basic unit. It measures whether the student has made a mistake involving the given basic unit in the response to a prompt or question. It measures whether the student has misused the unit in a writing task or a speaking task. It measures whether or not and how often the student has asked for help or additional information for the basic unit during a reading or listening task.

In addition to measuring the accuracy of the student's use of each basic unit, an implementation of the first embodiment also measures the student's proficiency by the time that it takes the student to recognize or produce a given basic unit or to complete other tasks involving the unit. In spoken responses, it measures whether the student hesitates or is fluent. Hesitations and disfluencies may be determined from the time aligned output of the speech recognition process.

Based on these measures of proficiency, optionally adjusted by the teacher, block 195 controls the selection of alternate representations in block 140. For example, as a student's proficiency progresses from beginner to intermediate a larger of fraction of the basic units will be presented in the language being studied, rather than in the student's native language. As another example, words that are new to an individual student's vocabulary may at first be presented with a gloss that translates the word into the student's native language. As the student's proficiency with the individual word improves, the glosses may be dropped a fraction of the time and then eliminated entirely as the student progresses further. If the student's proficiency with a particular basic unit drops, glosses may be re-introduced and extra unit-specific exercises may be added.

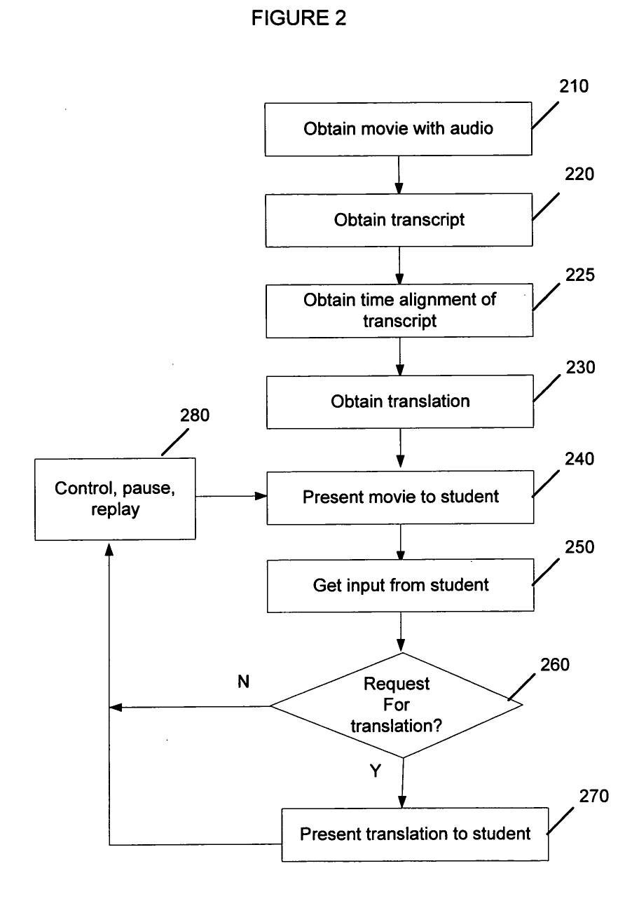

Referring now to FIG. 2, a flowchart is given for an example of the first embodiment of the invention in which the student is watching a movie or video with accompanying audio.

Block 210 of FIG. 2 obtains a movie or video with audio in the language being studied. In this example of the first embodiment, the movie would be a popular movie such as one that the student might regularly view even without any benefit of language instruction. The audio for the movie might be either the standard audio distributed with the movie, or might be audio that is especially recorded for use with language instruction. Specially recorded audio would be time synchronized to the video using techniques that are well known to those skilled in the art of dubbing foreign language audio for movies. The language to be studied will often be English, for which there are a large number of movies in which the original audio accompanying the movie is already in English. In an implementation of the first embodiment, the original audio or specially recorded audio that is time synchronized to the video would also be time aligned to any transcript (for example, as obtained in block 220 below) using time alignment techniques that are well-known to those skilled in the art of speech recognition, as discussed in reference to block 120 of FIG. 1 and as illustrated in pseudo code A below.

Block 220 of FIG. 2 obtains a transcript of the audio that accompanies the movie or video. In an implementation of the first embodiment, this transcript will be a transcription of the audio as spoken. In an implementation of the first embodiment, this transcription may be obtained either by having the audio transcribed by a professional transcriber, or by automatic speech recognition, or by one or more teams of students as a student exercise, as discussed in reference to block 190 of FIG. 1. Alternately, the transcript may be obtained by using an automatic speech recognition system. The errors made by the automatic speech recognition system may be corrected by students as a student exercise. If a plurality of teams or individual students prepare transcripts or correct the transcript prepared by an automatic speech recognition system working independently, then the independently derived transcriptions may be aligned using dynamic programming alignment as is well-known to those skilled in the art of speech recognition, using a text alignment program such as illustrated in pseudo code B below. At each word in the aligned transcripts, a consensus transcription is obtained by taking the word which agrees with the greatest number of the independent transcriptions.

Block 225 obtains a time alignment of the audio stream to the transcription obtained in block 220. In an implementation of the first embodiment, this alignment is computed by a speech recognition system. The process of computing a time alignment is well-known to those skilled in the art of speech recognition. If a speech recognition system is used in obtaining a transcription in block 220, then such a time alignment will generally already be available as a side effect of the recognition for transcription.

Block 230 obtains a translation of the transcription that has been prepared in block 220. In an implementation of the first embodiment, both a literal word-for-word translation and a more fluent translation are obtained. The literal word-for-word translation may be used, for example to provide glosses in subtitles for intermediate level students. The translations may be done either by professional translators, or may be done by teams of students as a student exercise, as discussed in reference to block 190 of FIG. 1. In an implementation of the first embodiment, audio may be optionally recorded corresponding to the word-for-word translation.

Block 240 presents the movie to the student. In an implementation of the first embodiment, the audio may be presented in a mixture of the two languages by substituting some words from the word-for-word translation for particular words in the original audio by chopping the audio stream at the word beginning and ending times found by the time alignment process. However, for greater fluency, even students with moderate proficiency may listen to the movie entirely in the language being studied, but with accompanying subtitles. Depending on the proficiency and personal preferences of the student, the subtitles may be in either of the languages or in a mixture of the two languages. The student will also have the ability to repeat portions of the movie and to request additional information, such as glosses and translations. In addition to presenting the movie with optional subtitles in either language, an implementation of the first embodiment optionally provides the transcription and the translation as text documents. These text documents may be either printed documents or documents presented by a computer system such that the student may, for example, highlight certain words or phrases using computer controls such as are common in word processing software. The student may then request additional information or repetition of the video corresponding to the highlighted words or phrases.

Block 250 obtains input from the student. The student will have rewind and playback controls as are standard for video playback systems. In addition, using the time alignment computed in block 225, the student can control the playback by selecting a particular word or phrase in the transcription document or the subtitles. Thus the student can listen again to a particular word or phrase without having to use the video controls to move forward to backward to exactly the right time. In an implementation of the first embodiment, the student will also be able to control the playback speed and hear the audio at a slower (or faster) speed than normal. The student would also have the ability to use the video controls to select the video corresponding to a particular word or phrase and to have the written form of that word or phrase displayed or translated.

In addition to controlling the rewinding and playing back of the video, the student can also request more information or help. Block 260 illustrates, by way of example and not as a limitation, an embodiment in which the student can highlight a particular word or phrase and request a translation. Block 260 checks whether a particular student input is such a request for a translation or is a command to control the playback system. The student may also select a particular word or phrase to be played back in isolation. In other possible implementations of the first embodiment, the student could ask for other forms of additional information.

Block 270 provides the translation or adds a gloss to the subtitles.

If the student input is a command, block 280 controls the presentation of the movie, as requested by the student.

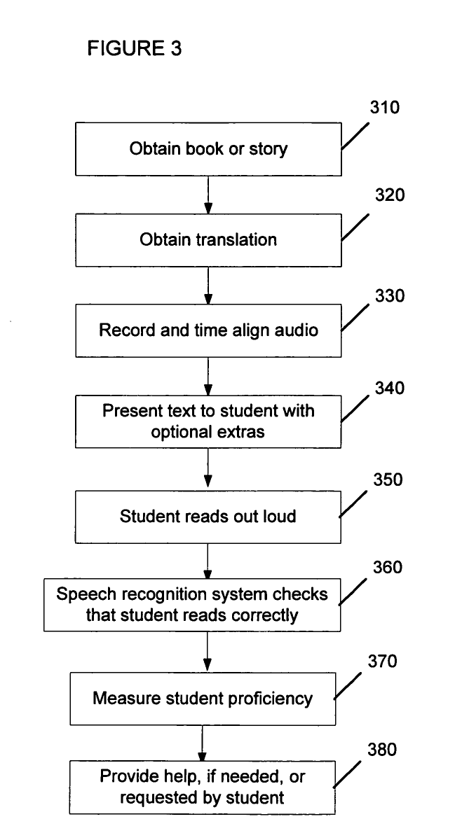

Referring now to FIG. 3, a flowchart is shown illustrating an example of the first embodiment in which the student reads a book or other text material out loud.

Block 310 of FIG. 3 obtains a book, story, essay or other written document. Typically the original written document will be in the language being studied. However, the original document may also be in the native language of the student.

Block 320 obtains a translation of the written document. If the original document is not in the language being studied, then a high quality, fluent translation must be obtained into the language being studied. For beginning students, it is also necessary to have a fluent translation into the native language of the student. To simplify the explanation, the method will first be described in the form used by intermediate and advanced students, which may also optionally be used by beginning students. Then, after blocks 330 and 340 have been discussed, a modification of the method which is designed for beginning students will be described.

For intermediate and advanced students, once a document is available in the language being studied, a “word-by-word” translation to the student's native language is obtained to be used as a training aid. This translation will not necessarily be exactly word-by-word, but rather will translate each “basic unit,” where a basic unit is the smallest unit that has a meaningful translation. For example, a proper name or a phrase with a unique meaning, such as “the White House” would be translated as a unit. This unit-by-unit translation will be used to provide alternate representations of the basic units for original presentation to the student, depending on the proficiency of the student. This translation will also be used to provide additional help to the student, upon request. The translations obtained in block 320 may be obtained either from a professional translator or by teams of students performing the translation as a student exercise.

For very advanced students, the translation obtained by block 320 is optional in an implementation of the first embodiment. In another aspect of the first embodiment, the system and/or method may be used for reading instruction in a language in which the student is already a fluent speaker. For such reading instruction, the translation obtained by block 320 is not necessary.

Block 330 obtains an audio recording of the text in the language being studied. In an implementation of the first embodiment, this audio recording would be fluent continuous speech by a native speaker. This recorded audio would then be time aligned to the written text, which is a well-known technique used in training speech recognition systems, and is illustrated in pseudo code A provided below at the end of this section. An implementation of the first embodiment allows for the ability to playback each separate word or unit in the text, either on request from the student or as an audio gloss in the main presentation.

Block 340 presents the text, selecting for each basic unit which of several alternate representations to present based on the student's general proficiency and the student's knowledge of the particular lexical items being presented. The alternate representations would include the translation of each unit into both the language being studied and the native language of the student. How many and which units are presented in each language is determined by the student's proficiency, based on criteria set by the course designer and adjusted by the teacher for the individual student. For example, the text may be presented to the student in a mixture of the two languages (the student's native language and another language to be learned by the student), depending upon the proficiency of the student. The alternate representations may also include glosses with unit-by-unit translations, phonetic transliterations, and/or accompanying audio.

For intermediate and advanced students, the word order of the presentation is the word order of the language being studied. For beginning students, however, an implementation of this embodiment offers the option of having the word order of the presentation be the word order of the native language of the student. This option may be used, for example, if for a majority of the material the selected alternate representation is in the student's native language or in the student's native language with a gloss in the language being studied. This option would allow material to be used that would otherwise be beyond the beginning student's vocabulary proficiency. Thus beginning students may use material with significant content, rather than specially written simple material. In particular, there would be no need to have adults use material written for children. In fact, beginning students could use the same material used by advanced students, but merely with a selection of alternate representations that are mostly in the student's native language.

When material is to be presented in the word order of the student's native language, block 320 obtains a high quality, fluent translation of the material into the student's native language and a word-by-word or unit-by-unit translation into the language being studied.

For the presentation in the word order of the student's native language there may be some units that do not occur in the inventory of audio units obtained in block 330 by time alignment to the transcript of the fluent translation into the language being studied. If so, then in this aspect block 330 would also separately record audio for any additional unit-by-unit translations that are needed.

In this aspect for beginning students, block 340 presents text in the word order of the native language of the student. Typically most words will be in the native language. Words that are within the existing vocabulary of the student in the language being studied and words that are to be learned in the current exercise may be presented in the language being studied. Based on the general proficiency of the student and the student's knowledge of the particular words involved, the presentation for such a unit may be just the unit as translated into the language being studied or it may be the unit presented in either language with a gloss in the other language.

For students of any proficiency, block 340 presents a sequence of alternate text representations that are at least partially in the language being studied and that optionally include glosses. In block 350 the student reads the presented material aloud and is recorded by the system. In an implementation of the first embodiment, the student would read only the basic presented form of each unit and not read the gloss aloud. In alternate implementations of the first embodiment, the student might also read the glosses aloud.

In block 360, speech recognition is applied to the recorded audio of the student reading aloud. In an implementation of the first embodiment, this speech recognition would be run in near real time so that the system can interact with the student and can measure the student's proficiency on an on-going basis without waiting until the student has finished reading the entire document.

In an implementation of the first embodiment, the speech recognition system checks for at least two things. It verifies that the student has read the correct sequence of words. It also measures the relative accuracy of the student's pronunciation by comparing the student's pronunciation with models created by training the speech recognition system on data from one or more native speakers of the language being studied.

Block 370 measures the student's proficiency based on several criteria. These criteria include whether the speech recognition system detects incorrect words, how much the student's pronunciation deviates from the models of native speakers, whether the student hesitates in reading a particular word, and whether the student asks for help on a particular word or unit. The relative weight for these criteria would depend on the student's objectives and the purpose of the particular lesson. For example, if the student's objective is merely to learn to read the language being studied, then less weight would be given to the accuracy of the student pronunciation. However, if the student's objective is to learn to speak the language fluently then substantial weight would be given to the accuracy of the pronunciation. In an optional feature of the first embodiment, these relative weights are be adjusted for each student by the teacher.

Block 380 provides additional help to the student. Help may be provided either because it is requested by the student or because the system determines that the student needs extra help with a particular unit. This help may include translations and glosses that are not part of the first presentation. It also may include audio for a given unit or sequence of units. It may include definitions or other explanations. The system may determine that the student needs help either because the student reads the wrong word, because the student hesitates, because the student's pronunciation is worse than some criterion, or because the student has had difficulty with the given unit in the past. The student may request additional help on any unit by, for example, highlighting the unit and clicking on it with a computer mouse.

The following pseudo code shows the computation of the time alignment between a transcription and an associated continuous speech audio file. This computation and many variations on it are well-known to those skilled in the art of speech recognition.

Pseudo Code A for Time Alignment of Transcript to Continuous Audio Stream

1. Train a large vocabulary speech recognition system with a model for each sound and a network representation of each word in the vocabulary (standard speech recognition training)

2. Create a network representing the particular transcript by concatenating network models for each of the words in the transcription

3. Find the best time alignment path in this concatenated transcript network aligned to the observed audio stream as follows:

Initialize alpha(0,0) = 1;
alpha(0,n) = 0 for all n >0;
For all time frames t in audio stream {

alpha(t,0) = alpha(t-1,0)*Prob(observations at time t | acoustic model for node 0);
Backpath(t,0) = 0;
For all nodes n >0 in transcript network {

If (alpha(t-1,n-1) >alpha(t-1,n)) {

Backpath(t,n) = n − 1;

```
  passScore = alpha(t-1,n-1);
} else {
  Backpath(t,n) = n;
  passScore = alpha(t-1,n);
}
alpha(t,n) = passScore*Prob(observations at time t | acoustic model for node n);
```

}

}
n = node at end of transcription network;
t = last frame time;
for t > 1 {

```
  Path(t) = n;
  n = Backpath(t,n);
  decrease t by 1
```

}

Path(t) then has the value of the node in the transcription network that aligns to time t. The time alignments of the nodes at the beginning and ending of each word may be used for breaking the audio stream into discrete basic units.

The quantity alpha(last frame time, node at end of network) is a measure of how well the particular audio stream matches the models. It can be used for measuring how well a student's pronunciation matches models that have been trained using data from native speakers.

The following Pseudo code B shows a text alignment computation similar to the acoustic time alignment in Pseudo code A. This text alignment may be used for aligning transcriptions or translations done by independent student teams or done independently by individual students.

Pseudo Code B for Aligning Text Sequences such as Student Transcriptions and Translations

Initialize alpha(0,0) = 0;
alpha(0,n) = n;
For all positions t in one text sequence {

alpha(t,0) = alpha(t-1,0) + 1;
Backpath(t,0) = 0;
For all positions n >0 in the other text sequence {

If (alpha(t-1,n-1) <alpha(t-1,n) +1) {

Backpath(t,n) = n − 1;

passScore = alpha(t-1,n-1);
} else {

Backpath(t,n) = n;

```
  passScore = alpha(t-1,n) + 1;
}
if (alpha(t,n-1) +1 <passScore) {
  Backpath(t,n) = Backpath(t,n-1);
  passScore = alpha(t,n-1) + 1;
}
alpha(t,n) = passScore;
if (word in position t of first sequence is different
```

from word in position n of second sequence {

increase alpha(t,n) by 1;
}

}

}
t = last position in first sequence;
n = last position in second sequence;
for t > 1 {

```
  Path(t) = n;
  n = Backpath(t);
  decrease t by 1
```

}

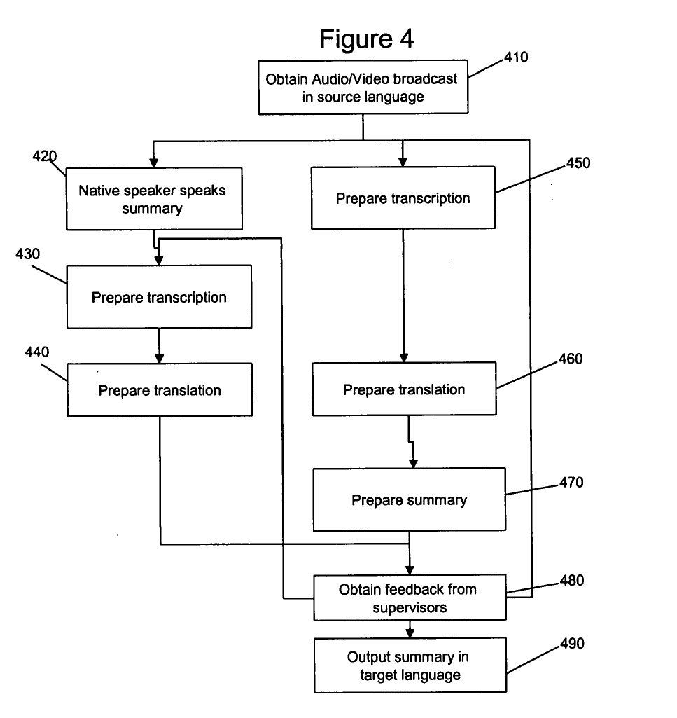

Referring now to FIG. 4, a second embodiment of the invention is illustrated in which the invention works as a linguistic data collection process. In the second embodiment, speech and text data generated by a team of one or more students are collected while the students complete a task as part of the study process. In the second embodiment, the team of students may be located at geographic dispersed sites. Each student has a local communications device, such as a personal computer or workstation or a cellular telephone. Each student communicates with other students or with the system through a user interface which is equipped to record all spoken or written data that is transmitted among the students. The communications are transmitted over a network, such as the Internet. The student team performs tasks involving one or more of the activities of transcription of speech, translation or summarization. The students interact with each other and with automatic systems for performing one or more of these tasks in the process of completing their assigned end-result task. In the course of performing these tasks, the students correct each other's errors and correct the errors of the automatic systems. The system records and logs these error corrections. This linguistic data collection process is explained more fully based on a particular example as illustrated in FIG. 4.

The example student team task in FIG. 4 is the task of obtaining a radio or television news broadcast in a source language and then translating and summarizing the news material in a second language (the target language). For example, the source language may be Chinese and the target language may be English.

In block 410, the audio or audio-video broadcast in the source language is obtained. To enrich the learning experience and to allow the students to learn from each other, the student team may include students of varying and complementary abilities. In particular, the team may include both native speakers of the source language and native speakers of the target language.

The original news broadcast may be summarized either before or after being translated, or both. In block 420, a native speaker of the source language, who may be one of the team members, listens to the original news broadcast and speaks a summary. The original broadcast and the summary spoken by the native speaker are recorded by the system as linguistic data, that is, as samples of speech in the source language.

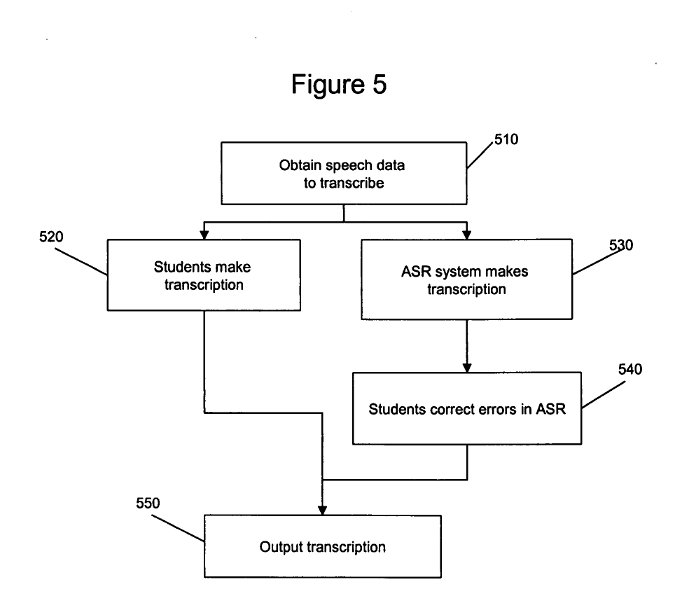

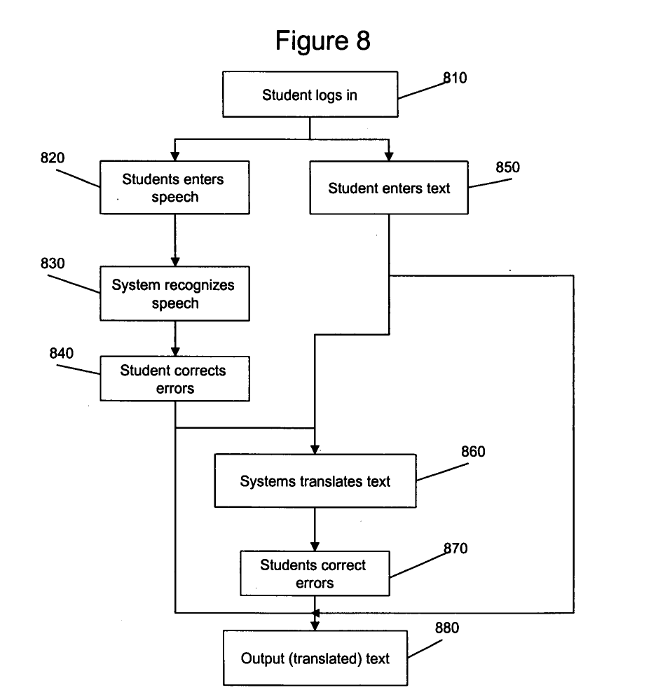

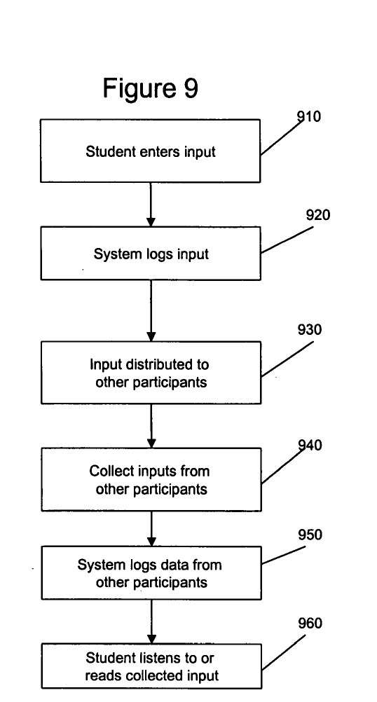

In block 430, a transcript is prepared of the summary from block 420. The students perform the transcription either manually or with the aid of an automatic speech recognition system in the source language, as illustrated in FIG. 5. Thus, block 430 produces a text version of the summary spoken in block 420. The communications among the students and between the students and the system, including corrections of errors made by the speech recognition system, are recorded and logged, as explained in more detail in reference to FIGS. 8 and 9.

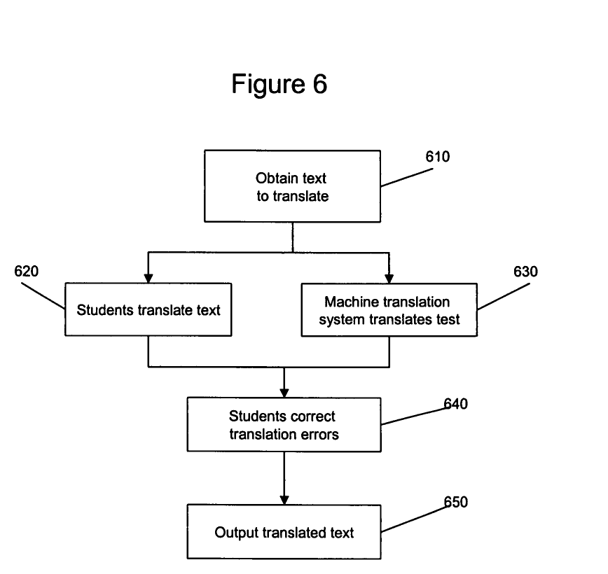

In block 440, a translation is prepared of the text summary from block 430. The students perform the translation either manually or with the aid of a machine translation system, as illustrated in FIG. 6. The text of the translated summary is then sent to block 480. The communications among the students and between the students and the system, including corrections of errors made by the machine translation system, are recorded and logged, as explained in more detail in reference to FIGS. 8 and 9.

Block 450 illustrates an alternative procedure, which may be used either in addition to or in place of the procedure that starts with block 420. In block 450, a transcript is prepared of the original news broadcast before being summarized. The preparation of the transcript of the original broadcast in block 450 is the same as the preparation of the transcript in block 430, as explained in more detail in reference to FIG. 5. The communications among the students and between the students and the system in doing the transcript preparation of block 450, including corrections of errors made by the speech recognition system, are recorded and logged, as explained in more detail in reference to FIGS. 8 and 9.

In block 460, a translation is prepared of the transcription text obtained in block 450, using the same process as block 440, as illustrated in more detail in reference to FIG. 6. The communications among the students and between the students and the system, including corrections of errors made by the machine translation system, are recorded and logged, as explained in more detail in reference to FIGS. 8 and 9.

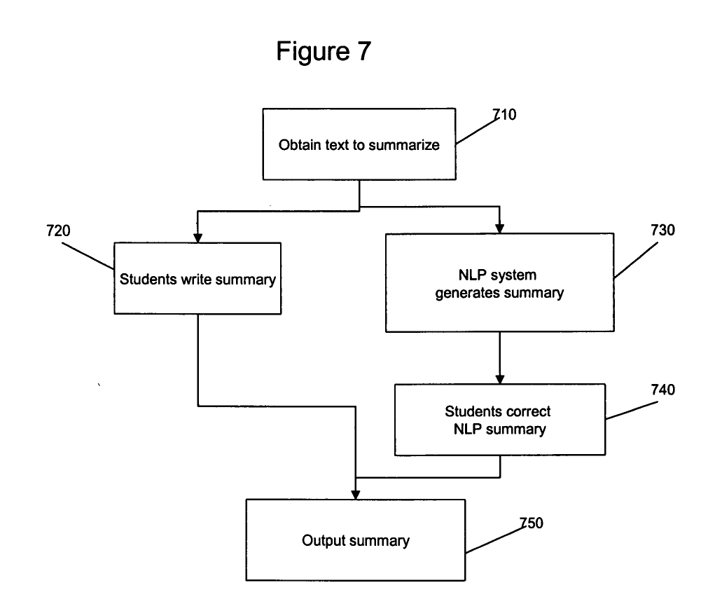

In block 470, a summary is prepared of the translated text received from block 460. The preparation of the summary may be done manually by the students or with the aid of a natural language processing (NLP) system, as explained in more detail in reference to FIG. 7.

In block 480, the students obtain feedback from one or more supervisors. The supervisors may be fellow students or may be more highly trained mentors or teachers. The feedback will indicate areas in which the students should check what they have produced, but may or may not specifically identify the errors.

After receiving feedback in block 480, the students return to either block 430 or block 450 and repeat the transcription and translation processes. The process then flows through again to send a text summary in the target language again to obtain feedback in block 480.

Once the students are satisfied with the summary that they have produced, given the feedback from block 480, the summary in the target language is output in block 490.

Referring now to FIG. 5, the process of preparing a transcription is illustrated, in accordance with the second embodiment of the invention. In block 510, speech data is obtained. This speech data will be saved and logged, if that has not already been done. The process then follows either or both of two alternative paths.

In block 520, the students make a transcription manually, by listening to the speech and writing what they hear. For the students this is an instructional exercise, so the transcription might be done first by students who are learning the source language and who may make a significant number of errors. In an implementation of this embodiment, other students, perhaps native speakers of the source language will help the original students correct their errors. The initial more errorful transcriptions, the communications between the students and the final transcriptions are all recorded and logged by the system as linguistic data.

In block 530, an automatic speech recognition is used to obtain an initial transcription. In block 540, students correct the errors made by the automatic speech recognition system. In an implementation of this embodiment, other students will help the first students find and correct the remaining errors. All versions of the transcription and all communication among the students is recorded and logged as linguistic data. In particular, the errors of the automatic speech recognition system and their corrections are recorded and logged.

In block 550, the final transcription is output.

Referring now to FIG. 6, the process of preparing a translation is illustrated, in accordance with the second embodiment. In block 610, text is obtained in the source language. This text is saved and logged as linguistic data, if that has not already been done. In block 620, one or more students translate the source text manually. Because this translation is prepared by students rather than professional translators, it is expected that the translation may contain errors. The translation is recorded and logged as linguistic data.

In block 630, a machine translation system is used to translate the text from the source language to the target language. The process may use either block 620 or block 630 or both. For a source language, target language pair for which machine translation is not available, the process may skip block 630 and use block 620 alone.

In block 640, one or more students correct the errors made by the original students or by the machine translation system. The errorful translations and the final translation are recorded and logged as linguistic data.

Block 650 outputs the final translation, as corrected by one or more students in block 640.

Referring now to FIG. 7, the process of preparing a summary is illustrated, in accordance with the second embodiment.

Block 710 obtains text to summarize. This text is saved and logged as linguistic data, if that has not already been done. Either or both of two alternative processes may then be used to prepare a summary of the obtained text.

In block 720, one or more students write a summary of the text. These students are not necessarily native speakers of the language of the text obtained in block 710 and this summarization process may be a learning exercise for the students. The summarization may be performed by a team of students, with the more advanced students correcting the work of other students. The summaries, corrections and communications among the students will all be recorded and logged as linguistic data.

In block 730, a natural language processing system is used to automatically generate a summary of the text obtained in block 710.

In block 740, one or more students correct the summary generated by the NLP system. The summary prepared by the NLP system, the corrections made by the students and any communications among the students are all recorded and logged as linguistic data.

Block 750 outputs the corrected summary.

The process illustrated in FIGS. 4-7 includes the collection of linguistic data at each stage of the process. This linguistic data will be valuable for training and improving automatic speech recognition systems, machine translation systems and natural language processing systems. A useful aspect of this data is that it contains data with errors that are subsequently corrected. Naturally occurring speech and text generally lacks this kind of error-correction data. It is an especially useful resource for improving the performance of the automatic processing systems.

Referring now to FIGS. 8 and 9, these figures show the process by which multi-lingual teams whose members are at physically separated locations communicate with each other with the aid of the system and the process by which the linguistic data is recorded, saved and logged, in accordance with a third embodiment of the invention.

FIG. 8 illustrates the process of a student speaking or entering text and of the text being translated to other languages to be communicated to other students.

In block 810, the student logs in to the system and sets his or her language preferences and whether to use spoken or typed input.

In block 820, the student speaks a message to be sent to another student or to the processing system. The spoken input is recorded, saved and logged as linguistic data.

In block 830, the speech is recognized by an automatic speech recognition system.

In block 840, the student corrects the errors made by the speech recognition system, if any. These error corrections are recorded and saved with links to the corresponding speech.

In block 850, the student enters text by typing rather than speaking. This text is saved and logged as linguistic data.

If the message is to be sent in one or more languages other than the original, block 860 translates the text. This translation is for the purpose of communication, not an instructional exercise, so the student does not try to translate without aid, but always uses the machine translation system as an aid.

In block 870, the original student and one or more students who are receiving the message cooperate to correct any errors in the translation. The original text, the translation and any error corrections are recorded and logged as linguistic data.

The translated text, or the untranslated text if the output language is the same as the input, is sent to block 880, which outputs the desired message.

Referring now to FIG. 9, the communication process among the collection of students is illustrated, in accordance with the third embodiment. In block 910, one particular student enters input. The input data may be either spoken or written, and the input process was described in detail in reference to FIG. 8.

In block 920, the system logs the input and the intermediate data and error corrections that were performed as part of the inputting process, and saves this data as linguistic data.

In block 930, the input message is distributed to the other participants in their respective preferred languages.

In block 940, responses or new input messages are collected from the other participants, again using the process described in reference to FIG. 8.

In block 950, the system logs and saves the data associated with the message input process for the other participants.

In block 960, the original student reads the responses. The student may be using a communications device, such as a cellular telephone, that is designed for speech. Optionally, the student may listen to the original speech, if the original message was spoken, or may listen to speech synthesized from the, perhaps translated, text message.

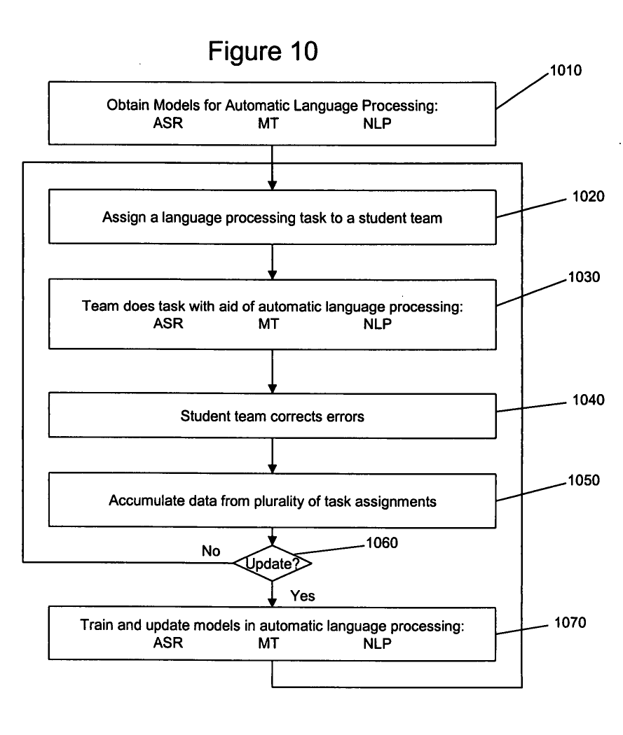

Referring now to FIG. 10, the process of training and updating the models for the automatic speech recognition (ASR), the machine translation (MT) and the natural language processing (NLP) summarization system is shown.

In block 1010, initial models are obtained for each of the automatic language processing systems (ASR, MT and NLP).

In block 1020, a language processing task is assigned to an individual student a student team, as described in reference to FIG. 4.

In block 1030, the student team performs the language processing task with the aid of at least one of the automatic language processing systems.

In block 1040, the student team corrects any errors made by the automatic language processing systems.

Block 1050 accumulates data from a plurality of language processing assignments. In an implementation of the third embodiment, there will be a large number of student teams. Preferably, the data will be accumulated over a plurality of teams as well as a plurality of assignments to each team.

Block 1060 decides, based on a predetermined criterion, whether to update the models in the automatic language processing system or to continue accumulating data before updating. For example, block 1060 could simply compare the quantity of data accumulated since the last model update with a preset quantity. The quantity of data to collect before updating the models affects the efficiency rather than the correctness of the training process. The process will work with an arbitrarily chosen value. Efficiency may be optimized by trying several values, testing their efficiency, and choosing the most efficient.

If the decision in block 1060 is not to update the models, then control flow returns to block 1020 to collect more data from another student team task assignment.

If the decision in block 1060 is to update the models, then control flows to block 1070.

In block 1070, the models for each of the automatic language processing systems are trained or updated. Available commercial and university automatic language processing systems have mechanisms allowing an external application program to supply training data to the automatic language processing system so that the automatic language processing system (whether an ASR, MT or NLP system) will update its models. Block 1070 uses these built-in mechanisms within the automatic language processing systems to update the models, given the data that has been collected.

After the update in block 1070 is completed, control returns to block 1020 to repeat the process of collecting more data and again updating the models. This process results in on-going, continuing improvement in the models used by the automatic language processing systems.

It should be noted that although the flow charts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

Different embodiments of the present invention have been described according to the present invention. Many modifications and variations may be made to the techniques and structures described and illustrated herein without departing from the spirit and scope of the invention. Accordingly, it should be understood that the apparatuses described herein are illustrative only and are not limiting upon the scope of the invention.

1. A method of interactive language instruction, comprising:
obtaining a sequence of basic units to present to a student;
obtaining at least one alternate representation for each of a plurality of said basic units;
presenting at least a portion of said sequence of basic units to said student;
obtaining input from said student during said presenting of said basic units;
for at least one of said sequence of basic units to be presented to said student and said input from said student, performing segmentation to break up a continuous stream of units into a sequence of discrete units; and
for at least one particular basic unit with said at least one alternate representation, automatically selecting said at least one alternate representation to present to said student based at least in part on said input obtained from said student during said presentation of basic units that are earlier in said sequence of basic units than said particular basic unit.

2. A method of interactive language instruction as in claim 1, further comprising:
presenting a second portion of the sequence of basic units to the student, along with said at least one alternate representation.

3. A method of interactive language instruction as in claim 1, wherein said sequence of basic units includes a sequence of spoken units or words.

4. A method of interactive language instruction as in claim 1, wherein said input from said student includes speech.

5. A method of interactive language instruction as in claim 1, wherein said input from said student includes responses to prompts in said sequence of basic units.

6. A method of interactive language instruction as in claim 1, wherein said input from said student includes requests from said student for additional assistance.

7. A method of interactive language instruction as in claim 1, wherein said alternate representations for said basic units include representations in a plurality of different languages.

8. A method of interactive language instruction as in claim 1, wherein said presenting of said sequence of basic units includes presenting at least one unit in each of a plurality of different languages.

9. A method of interactive language instruction as in claim 1, wherein at least one of said alternate representations of at least one particular one of said basic units is a base version of said basic unit and at least one of said alternate representations of said particular unit includes said base version and a gloss of said base version.

10. A method of interactive language instruction as in claim 9, wherein said gloss comprises a translation of said base version.

11. A method of interactive language instruction as in claim 9, wherein said gloss comprises a definition of said particular basic unit.

12. A method of interactive language instruction as in claim 9, wherein said gloss comprises an explanation of said particular basic unit.

13. A method of interactive language instruction as in claim 1, further comprising:
modifying at least one of said alternate representations prior to presenting it to said student,
wherein said at least one of said alternate representations has been modified to be easier to comprehend.

14. A method of interactive language instruction as in claim 1, wherein said sequence of basic units include spoken units and said alternate representations include units presented at different audio speeds.

15. A method of interactive language instruction as in claim 1, wherein said sequence of basic units includes an audio stream containing speech.

16. A method of interactive language instruction as in claim 15, wherein said sequence of basic units comprises an audio-video presentation.

17. A method of interactive language instruction as in claim 15, further comprising controlling said presentation of said audio stream based on said input from said student.

18. A method of interactive language instruction as in claim 17, further comprising a video presentation and synchronizing said video presentation with said audio stream.

19. A method of interactive language instruction as in claim 17, wherein said controlling of said presentation includes repeating portions of said presentation.

20. A method of interactive language instruction as in claim 17, wherein said controlling of said presentation includes a selecting by said student of a subsequence of at least one of said basic units to be presented in isolation.

21. A method of interactive language instruction as in claim 15, further comprising selecting a subsequence of at least one of said basic units based on said input from said student.

22. A method of interactive language instruction as in claim 21, further comprising presenting a written representation of said subsequence to said student.

23. A method of interactive language instruction as in claim 21, further comprising presenting a gloss of said subsequence to said student.

24. A method of interactive language instruction as in claim 1, wherein said sequence of basic units includes a plurality of basic units in the form of written text.

25. A method of interactive language instruction as in claim 24, wherein said sequence of basic units includes basic units in a plurality of different languages.

26. A method of interactive language instruction as in claim 24 wherein, for at least one of said basic units, said alternate representations include representations in a plurality of different languages.

27. A method of interactive language instruction as in claim 1, further comprising measuring the proficiency of said student.

28. A method of interactive language instruction as in claim 27, wherein said selecting of at least one alternate representation is based at least in part on said measuring of the proficiency of said student.

29. A method of interactive language instruction as in claim 1, further comprising measuring the knowledge of said student of each of a plurality of said basic units.

30. A method of interactive language instruction as in claim 29, further comprising for at least one particular basic unit with said plurality of alternate representations selecting the representations to be presented based on said measured knowledge of said student of said particular basic unit.

31. A method of interactive language instruction as in claim 29, wherein said measuring of said knowledge of said student of said basic units includes counting how many times each given basic unit has been presented to said student over a given interval of instruction.

32. A method of interactive language instruction as in claim 31, further comprising computing for said sequence of basic the set of basic units in said sequence which have been presented to said student less than a specified number of times during said given interval of instruction.

33. A method of interactive language instruction as in claim 32, wherein said interval of instruction is an entire period of instruction for said student.

34. A method of interactive language instruction as in claim 32, wherein said specified number of times is one.

35. A method of interactive language instruction as in claim 32, further comprising selecting for at least one particular one of said basic units with a plurality of alternate representations said alternate representation to be presented based at least in part on whether said particular basic unit is in said set of basic units which have been presented less than said specified number of times.

36. A method of interactive language instruction as in claim 32, further comprising for a plurality of said basic units a plurality of representations are provided such that at least one representation is designated as relatively more difficult for said student and at least one representation is designated as relatively more easy for said student.

37. A method of interactive language instruction as in claim 36, wherein said at least one representation designated as relatively more difficult is a representation in a language which said student is learning.

38. A method of interactive language instruction as in claim 37, wherein said at least one representation designated as relatively more easy is a representation in a language with which said student is more familiar than said language which said student is learning.

39. A method of interactive language instruction as in claim 36, further comprising selecting said alternate representations to be presented so as to control the relative proportion of presented representations that are designated as relatively hard.

40. A method of interactive language instruction as in claim 1, wherein said input from said student includes spoken input.

41. A method of interactive language instruction as in claim 40, further comprising using automatic speech recognition to recognize the words spoken by said student.

42. A method of interactive language instruction as in claim 40, further comprising using automatic speech recognition to recognize the pronunciation spoken by said student.

43. A method of interactive language instruction as in claim 42, further comprising judging whether the student has given a designated correct pronunciation.

44. A method of interactive language instruction as in claim 42, further comprising modeling the expected pronunciations based at least in part on the native language of said student.

45. A method of interactive language instruction as in claim 1, wherein said sequence of basic units includes spoken units and said alternate representations include text corresponding to said spoken units.

46. A method of interactive language instruction as in claim 45, wherein said obtaining of said alternate representation comprises performing automatic speech recognition on said spoken units.

47. A method of interactive language instruction as in claim 1, wherein said obtaining of alternate representations is based in part on translations prepared by professional translators.

48. A method of interactive language instruction as in claim 1, wherein said obtaining of alternate representations includes making speech recordings of written material that is read out loud.

49. A method of interactive language instruction as in claim 1, wherein said obtaining of alternate representations is based in part on input from a plurality of students during interactive presentation of said sequence of basic units.

50. A method of interactive language instruction as in claim 1, wherein said obtaining of alternate representations includes using automatic speech recognition to obtain text transcripts of spoken material.

51. A method of interactive language instruction as in claim 50, further comprising presenting to at least one student the task of correcting an errorful transcript that is derived at least in part from said automatic speech recognition.

52. A method of interactive language instruction as in claim 51, further comprising obtaining a transcript by combining the input from a plurality of students.

53. A method of interactive language instruction as in claim 1, wherein said obtaining of alternate representations is based in part on translations prepared by automatic translation.

54. A method of interactive language instruction as in claim 1, wherein said obtaining of alternate representations is based in part on translations prepared by at least one student.

55. A method of interactive language instruction as in claim 54, further comprising combining the results of translations prepared by a plurality of students.

56. A method of interactive language instruction as in claim 27, wherein said sequence of basic units is the same for a plurality of students and said selection of alternate representations is different based on the difference in proficiency of said students.

57. A method of interactive language instruction as in claim 1, further comprising obtaining a time alignment of a network of speech recognition models for the words in a transcription of an audio stream to the acoustic observations in the audio stream.

58. A method of interactive language instruction as in claim 57, wherein said transcription is obtained in part from said sequence of basic units.

59. A method of interactive language instruction as in claim 58, wherein said performing of segmentation to break up said continuous stream is based on said time alignment.

60. A method of interactive language instruction as in claim 1, further comprising making a connection to a computer network.

61. A method of interactive language instruction as in claim 60, further comprising providing communication over said computer network between said student and other students performing a team project with said student.

62. A method of interactive language instruction as in claim 60, further comprising recording at least one response of said student and transmitting said at least one response over said computer network to a teacher.

63. A method of interactive language instruction as in claim 27, further comprising transmitting said measurement of proficiency of said student over a computer network.

64. A method of interactive language instruction as in claim 61, wherein said team of students are in a plurality of geographic locations.

65. A method of interactive language instruction as in claim 62, wherein said student and said teacher are in different geographic locations.

66. A method of interactive language instruction as in claim 60, further comprising receiving control instructions from a teacher over said network.

67. A method of interactive language instruction as in claim 66, further comprising basing said selection of said at least one alternate representation at least in part on said control instructions from said teacher.

68. A method for linguistic data collection comprising:
assigning a language processing task to at least one student, said language processing task including at least one of transcription of speech, translation from a source language to a target language, and summarization;
recording and saving spoken and text data of said at least one student produced in a process of performing said assigned language processing task as linguistic data; and
automatically creating a collection of linguistic data for a plurality of instances of assigning the language processing task to the at least one student.

69. A method of linguistic data collection as in claim 68, further comprising:
using an automatic speech recognition system to recognize speech for said language processing task;
assigning to said at least one student a task of correcting the errors of said automatic speech recognition system;
recording and saving the error corrections performed by said at least one student together with links to the corresponding speech as linguistic data; and
updating models within said speech recognition system based on said linguistic data.

70. A method of linguistic data collection as in claim 68, further comprising:
using a machine translation system for said language processing task;
assigning to said at least one student a task of correcting the errors made by said machine translation system; and
recording and saving the error corrections performed by said at least one student as linguistic data.

71. A method of linguistic data collection as in claim 68, further comprising:
using a natural language processing system to generate summaries for said language processing task;
assigning to said at least one student a task of correcting the summary made by said natural language processing system; and
recording and saving the original text, the summary generated by said natural language processing system, and the corrected summary made by said at least one student as linguistic data.

72. A method of linguistic data collection as in claim 68, further comprising:
assigning a plurality of students a task of working as a team to perform said language processing task;
providing to said plurality of students a communications system to communicate for a purpose of performing said language processing task; and
recording and saving the communications among said students in the performance of said language processing task as linguistic data.

73. A method of linguistic data collection as in claim 72, further comprising:
providing a translation system to allow said plurality of students to communicate in a plurality of languages;
providing a communications system for said students to correct the translations produced by said translation means;
recording and saving the translations produced by said translation system and the corrections made to the produced translation by said students as linguistic data; and
updating models within said speech recognition system based on said linguistic data.

74. A method for training an automatic language processing system comprising:
obtaining an initial set of models for at least one automatic language processing system; and
repeating the following steps a plurality of times:
i. assigning a language processing task to a student team;
ii. having said student team perform said language processing task with the aid of said at least one automatic language processing system;
iii. having said student team correct the errors made by said at least one automatic language processing system; and
iv. accumulating data from a plurality of task assignments in this repeated process; and
updating language models in said at least one automatic language processing system based on said accumulated data.

75. A method for training an automatic language processing system as in claim 74, wherein said at least one automatic language processing system includes at least one automatic speech recognition system.

76. A method for training an automatic language processing system as in claim 74, wherein said at least one automatic language processing system includes at least one machine translation system.

77. A method for training an automatic language processing system as in claim 74, wherein said at least one automatic language processing system includes at least a natural language processing summarization system.

78. A method for training an automatic language processing system as in claim 74, wherein said at least one automatic language processing system includes a plurality of automatic language processing systems.

79. A method for training an automatic language processing system as in claim 78, wherein said plurality of automatic language processing systems includes at least one automatic speech recognition system, at least one machine translation system, and at least one natural language processing summarization system.

80. A program product having machine-readable program code for performing speech recognition, the program code, when executed, causing a machine to perform the following steps:
assigning a language processing task to at least one student, said language processing task including at least one of transcription of speech, translation from a source language to a target language, and summarization;
recording and saving spoken and text data of said at least one student produced in a process of performing said assigned language processing task as linguistic data; and
creating a collection of linguistic data for a plurality of instances of assigning the language processing task to the at least one student.

81. A program product as in claim 80, further comprising:
using an automatic speech recognition system to recognize speech for said language processing task;
assigning to said at least one student a task of correcting the errors of said automatic speech recognition system; and
recording and saving the error corrections performed by said at least one student together with links to the corresponding speech as linguistic data.

82. A program product as in claim 80, further comprising:
using a machine translation system for said language processing task;
assigning to said at least one student a task of correcting the errors made by said machine translation system; and
recording and saving the error corrections performed by said at least one student as linguistic data.

83. A program product as in claim 80, further comprising:
using a natural language processing system to generate summaries for said language processing task;
assigning to said at least one student a task of correcting the summary made by said natural language processing system; and
recording and saving the original text, the summary generated by said natural language processing system, and the corrected summary made by said at least one student as linguistic data.

84. A program product as in claim 80, further comprising:
assigning a plurality of students a task of working as a team to perform said language processing task;
providing to said plurality of students a communications system to communicate for a purpose of performing said language processing task; and
recording and saving the communications among said students in the performance of said language processing task as linguistic data.

85. A program product as in claim 84, further comprising:
providing a translation system to allow said plurality of students to communicate in a plurality of languages;
providing a communications system for said students to correct the translations produced by said translation means; and
recording and saving the translations produced by said translation system and the corrections made to the produced translation by said students as linguistic data.

86. A program product having machine-readable program code for performing speech recognition, the program code, when executed, causing a machine to perform the following steps:
obtaining an initial set of models for at least one automatic language processing system; and
repeating the following steps a plurality of times:
v. assigning a language processing task to a student team;
vi. having said student team perform said language processing task with the aid of said at least one automatic language processing system;
vii. having said student team correct the errors made by said at least one automatic language processing system; and
viii. accumulating data from a plurality of task assignments in this repeated process; and
updating language models in said at least one automatic language processing system based on said accumulated data.

87. A program product as in claim 86, wherein said at least one automatic language processing system includes at least one automatic speech recognition system.

88. A program product as in claim 86, wherein said at least one automatic language processing system includes at least one machine translation system.

89. A program product as in claim 86, wherein said at least one automatic language processing system includes at least a natural language processing summarization system.

90. A program product as in claim 86, wherein said at least one automatic language processing system includes a plurality of automatic language processing systems.

91. A program product as in claim 90, wherein said plurality of automatic language processing systems includes at least one automatic speech recognition system, at least one machine translation system, and at least one natural language processing summarization system.
